(19) United States
(12) Patent Application Publication
(10) Pub. No.: US 2013/0190454 A1
(43) Pub. Date: Jul. 25, 2013

(54) COMPOSITIONS COMPRISING LACTAM

(71) Applicant: BASF SE, Ludwigshafen (DE)

(72) Inventors: Philippe Desbois, Edingen-Neckarhausen (DE); Andreas Wollny, Freinsheim (DE); Andreas Radtke, Mannheim (DE); Anna Karina Möller, Darmstadt (DE)

(73) Assignee: BASF SE, Ludwigshafen (DE)

(21) Appl. No.: 13/744,553

(22) Filed: Jan. 18, 2013

Related U.S. Application Data
(60) Provisional application No. 61/588,185, filed on Jan. 19, 2012.

(51) Int. Cl. C08L 77/02

(52) U.S. Cl. CPC C08L 77/02
USPC 525/179; 264/257

(57) ABSTRACT

The invention relates to a composition comprising the following components:
(A) at least one lactam
(B) at least one catalyst
(C) an activator from the group of the isocyanates, anhydrides, acyl halides, reaction products of these with (A), and mixtures of these
(D) at least one non-functionalized rubber, which comprises no functional groups having heteroatoms
(E) at least one hydroxy-terminated rubber.

This patent application claims the benefit of pending U.S. provisional patent application Ser. No. US 61/588,185 filed on Jan. 19, 2012, incorporated in its entirety herein by reference.

The invention relates to a composition comprising the following components:
(A) at least one lactam
(B) at least one catalyst
(C) an activator from the group of the isocyanates, anhydrides, acyl halides, reaction products of these with (A), and mixtures of these
(D) at least one non-functionalized rubber, which comprises no functional groups having heteroatoms
(E) at least one hydroxy-terminated rubber.

The invention further relates to a composition comprising the following components:
(A) at least one lactam
(B) at least one catalyst
(C) an activator from the group of the isocyanates, anhydrides, acyl halides, reaction products of these with (A), and mixtures of these
(D) at least one non-functionalized rubber
(E) at least one hydroxy-terminated rubber.

The invention also relates to processes for producing a molding comprising the following steps:
(a) producing separate mixtures
   s1) comprising at least one lactam (A), one activator (C), and one functionalized rubber (E)
   s2) comprising at least one lactam (A) and at least one catalyst (B), and one non-functionalized rubber (D), which comprises no functional groups having heteroatoms
(b) injecting the combined mixtures s1) and s2) into a hot mold with inserted textile structure
(c) ejecting the resultant molding from the mold.

The invention further also relates to processes for producing a molding comprising the following steps:
(a) producing separate mixtures
   s1) comprising at least one lactam (A), one activator (C), and one functionalized rubber (E)
   s2) comprising at least one lactam (A) and at least one catalyst (B), and one non-functionalized rubber (D)
(b) injecting the combined mixtures s1) and s2) into a hot mold with inserted textile structure
(c) ejecting the resultant molding from the mold.

The invention also relates to processes for producing a molding comprising the following steps:
(a) producing separate mixtures
   s1) comprising at least one lactam (A), one activator (C), one functionalized rubber (E), and one non-functionalized rubber (D), which comprises no functional groups having heteroatoms
   s2) comprising at least one lactam (A) and at least one catalyst (B), and one non-functionalized rubber (D)
(b) injecting the combined mixtures s1) and s2) into a hot mold with inserted textile structure
(c) ejecting the resultant molding from the mold.

The invention further also relates to processes for producing a molding comprising the following steps:
(a) producing separate mixtures
   s1) comprising at least one lactam (A), one activator (C), one functionalized rubber (E), and one non-functionalized rubber (D)
   s2) comprising at least one lactam (A) and at least one catalyst (B), and one non-functionalized rubber (D)
(b) injecting the combined mixtures s1) and s2) into a hot mold with inserted textile structure
(c) ejecting the resultant molding from the mold.

The present invention further relates to moldings obtainable by the process described.

Lactams, such as caprolactam, can be polymerized anionically. The production of polyamide moldings is known per se to the person skilled in the art.

DE 3 534 949 discloses non-functionalized polybutadienes as additives to lactam melts.

The document EP 243 177 describes the use of polybutadiene having OH end groups and molar masses of from 400 to 3000 g/mol in the activated anionic polymerization of lactams.

An object was to provide a composition comprising at least one lactam and, capable of polymerization. The composition should permit reaction to give polyamide directly and without the prior and/or separate formation of prepolymers.

After polymerization, the composition should produce moldings having a homogeneous morphology.

In particular, no components of the composition should migrate out to the surface of a molding polymerized to give polyamide and thus exhibit what is known as an exudation effect. Even if there was a requirement to add an additive to the composition, the intention was to ensure that the intrinsic viscosity of the resultant polyamide does not significantly deviate from that of the pure polyamide, the aim being to allow processing in existing equipment.

The intention was that moldings produced from the composition by processes described above can be ejected easily from the mold used for the production process. The resultant moldings were intended to have high puncture resistance.

As described in the introduction, the invention uses at least one lactam as component (A). A particularly suitable lactam is caprolactam, piperidone, pyrrolidone, or laurolactam. It is also possible to use mixtures of different lactams. It is preferable to use caprolactam, laurolactam, or a mixture of these. It is particularly preferable to use caprolactam or laurolactam as component (A).

In one embodiment it is possible to use, as component (A), instead of a lactam, a mixture made of lactam and lactone. An example of lactones that can be used is caprolactone or butyrolactone.

If a lactone is used concomitantly as comonomer, the amounts thereof typically used are from 0.01 to 40% by weight, based on the total monomer. The proportion of lactone as comonomer is preferably from 0.01 to 30% by weight, particularly preferably from 0.01 to 20% by weight, based on the total monomer.

One preferred embodiment of the invention uses exclusively lactams as component (A).

The composition of the invention comprises a catalyst (B). For the purposes of the present invention, a catalyst for the anionic polymerization process is a compound which permits the formation of lactam anions. The lactam anions per se can likewise function as catalyst.

Catalysts of this type are known by way of example from Polyamide, Kunststoffhandbuch [Polyamides, Plastics handbook], 1998, Karl Hauser Verlag. For the purposes of the present invention, it is preferable to use a catalyst (B) selected from the group consisting of alkali metal caprolactamates, such as sodium caprolactamate or potassium caprolactamate, alkaline earth metal caprolactamates, such as magnesium bromide caprolactamate, magnesium chloride caprolactamate, or magnesium biscaprolactamate, alkali metals, such as sodium or potassium, alkali metal bases, e.g. sodium bases, such as sodium hydride, sodium, sodium hydroxide, sodium methanolate, sodium ethanolate, sodium propanloate, or sodium butanolate, or, for example, potassium bases, such as potassium hydride, potassium, potassium hydroxide, potassium methanolate, potassium ethanolate, potassium propanolate, potassium butanolate, or a mixture of these, preferably composed of sodium caprolactamate, potassium caprolactamate, magnesium bromide caprolactamate, magnesium chloride caprolactamate, magnesium biscaprolactamate, sodium hydride, sodium, sodium hydroxide, sodium ethanolate, sodium methanolate, sodium propanolate, sodium butanolate, potassium hydride, potassium, potassium hydroxide, potassium methanolate, potassium ethanolate, potassium propanolate, potassium butanolate, or a mixture of these.

It is particularly preferable to use a catalyst (B) selected from the group consisting of sodium hydride, sodium, and sodium caprolactamate, and mixtures of these; particular preference is given to sodium caprolactamate. The catalyst can be used in the form of solid or in solution. It is preferable to use the catalyst in the form of solid. The catalyst is preferably added to a caprolactam melt in which it can be dissolved. These catalysts effect a particularly fast reaction, thereby increasing the efficiency of the production process for the composition according to the present invention.

The molar ratio of lactam (A) to catalyst (B) can be varied widely, being generally from 1:1 to 10 000:1, preferably from 5:1 to 1000:1, particularly preferably from 5:1 to 500:1.

As activator (C) for the anionic polymerization process, a compound is selected from the group of the lactams N-substituted by electrophilic moieties, of the aliphatic diisocyanates, of the aromatic diisocyanates, of the polyisocyanates having more than two isocyanate groups, and of the aliphatic diacyl halides and aromatic diacyl halides. It is also possible to use a mixture thereof as activator (C).

Among the lactams N-substituted by electrophilic moieties are by way of example acyllactams. Precursors for these activated N-substituted lactams, where these together with the lactam (A) form an activated lactam in situ, can also be activator (C).

Activators comprising isocyabate moieties are particulrarly suitable, as they effect a faster reaction compared to acid halide-based activators.

Among aliphatic diisocyanates suitable as activator (C) are compounds such as butylene diisocyanate, hexamethylene diisocyanate, octamethylene diisocyanate, decamethylene diisocyanate, undecamethylene diisocyanate, dodecamethylene diisocyanate, 4,4′-methylene-bis(cyclohexyl isocyanate), and isophorone diisocyanate. Suitable aromatic diisocyanates are inter alia tolyl diisocyanate, 4,4′-methylenebis(phenyl isocyanate), or polyisocyanates having more than two isocyanate groups, for example Basonat HI 100 from BASF SE, and allophanates (e.g. ethyl allophanate). In particular, mixtures of the compounds mentioned can be used as activator (C).

Suitable aliphatic diacyl halides are compounds such as butylenedioyl chloride, butylenedioyl bromide, hexamethylenedioyl chloride, hexamethylenedioyl bromide, octamethylenedioyl chloride, octamethylenedioyl bromide, decamethylenedioyl chloride, decamethylenedioyl bromide, dodecamethylenedioyl chloride, dodecamethylenedioyl bromide, 4,4′-methylene-bis(cyclohexyloyl chloride), 4,4′-methylenebis(cyclohexyloyl bromide), isophoronedioyl chloride, and isophoronedioyl bromide. Suitable aromatic diacyl halides are inter alia tolylmethylenedioyl chloride, 4,4′-methylenebis(phenyloyl chloride), or 4,4′-methylenebis(phenyloyl bromide). In particular, mixtures of the compounds mentioned can be used as activator (C). In one preferred embodiment, activator (C) used comprises at least one compound selected from the group comprising hexamethylene diisocyanate, isophorone diisocyanate, hexamethylenedioyl bromide, hexamethylenedioyl chloride, and mixtures of these. It is particularly preferable to use hexamethylene diisocyanate. The activator (C) can be used in solid form or in the form of mixture. In particular, the activator can be dissolved in caprolactam. An example of a suitable activator (C) is Bruggolen® C20, 80% caprolactam-capped 1,6-hexamethylene diisocyanate in caprolactam from Brüggemann, D E.

The amount of activator (C) defines the number of the growing chains, since each activator molecule represents the initial member of a polymer chain. The molar ratio of lactam (A) to activator (C) can vary widely, and is generally from 1:1 to 10 000:1, preferably from 5:1 to 2000:1, particularly preferably from 20:1 to 1000:1.

Hydrocarbon-based rubbers are suitable as non-functionalized rubber (D). The term rubber is used in accordance with DIN 53 501, and relates to uncrosslinked polymers which are crosslinkable and at room temperature have elastomeric properties. The expression “non-functionalized rubber” relates to rubbers which comprise no functional groups having heteroatoms. The term “heteroatom” is to be understood in the sense of the present invention to preferably comprise oxygen (O), nitrogen (N), sulfur (S) and phosphor (P).

Because of lacking functional groups, presence of a non-functionalized rubber (D) results in a particular homogenous morphology, this morphology differing from morphologies obtained by common functionalized rubbers. The morphology obtained by the present invention, due to its homogeneity, advantageously effects the mechanical properties of the composition, in particular the mechanical properties of moldings obtainable from the the composition according to the present invention.

Non-functionalized rubbers which are particularly suitable are those where the molar mass Mw is from 500 to 300 000 g/mol, in particular from 1000 to 150 000 g/mol, determined from GPC with light scattering in hexafluoroisopropanol (HFIP) at 40° C.

Non-functionalized rubbers that are suitable are those with a Tg value of from −150° C. to 25° C., determined under nitrogen as inert gas by Differential Scanning calorimetry (DSC) with a start temperature of −180° C., an end temperature of 200° C., and a heating rate of 20 [K/min].

Non-functionalized rubber (D) used can comprise diene-based rubbers, such as synthetic polyisoprene rubber, polybutadiene rubber, polyisobutylene-polybutene-butyl rubber, ethylene-propylene-copolymer rubbers, ethylene-1-butene-copolymer rubbers, ethylene-propylene-1-butene-copolymer rubbers, ethylene-1-hexene-copolymer rubbers, ethylene-1-octene-copolymer rubbers, ethylene-styrene-copolymer rubbers, ethylene-norbornene-copolymer rubbers, propylene-1-butene-copolymer elastomer, ethylene-1-butene-unconjugated-diene-copolymer elastomer, and mixtures thereof. Non-functionalized rubbers (D) of this type can be produced as described in “Kautschuktechnologie: Werkstoffe-Verarbeitung—Produkte” [Rubber technology: Materials—processing—products] from F. Röthemeyer and F. Sommer, p. 81 and p.122, by coordinative anionic polymerization in solution, in suspension, or in the gas phase, with Ziegler-Natta catalysts.

It is also possible to use non-functionalized styrene rubbers, styrene-butadiene-diblock copolymers, such as styrene-butadiene-styrene-triblock copolymers, styrene-isoprene-diblock copolymers, styrene-isoprene-styrene-triblock copolymers, hydrogenated styrene-butadiene-diblock copolymers, hydrogenated styrene-butadiene-styrene triblock copolymers, hydrogenated styrene-isoprene-diblock copolymers, styrene-isoprene-styrene-triblock copolymers, and mixtures thereof. Non-functionalized rubbers (D) of this type can be produced as described in “Kautschuktechnologie: Werkstoffe-Verarbeitung—Produkte” [Rubber technology: Materials—processing—products] from F. Röthemeyer and F. Sommer, pp. 94-98, via free-radical emulsion polymerization or via anionic solution polymerization.

It is also possible to use non-functionalized random styrene-butadiene copolymers, random styrene-isoprene copolymers, random hydrogenated styrene-butadiene copolymers, random hydrogenated styrene-isoprene copolymers, and mixtures thereof. Non-functionalized rubbers of this type can by way of example be produced in accordance with EP-A 0859803 via anionic polymerization, e.g. by means of alkyllithium compounds in a non-polar solvent, where the polymerization of at least one soft phase is undertaken in the presence of, for example, a soluble potassium salt.

It is also possible to use mixtures of component (D).

Hydroxy-terminated hydrocarbon-based rubbers are a suitable hydroxy-terminated rubber (E). The expression “hydroxy-terminated rubber” refers to rubbers which bear hydroxy groups at respective chain ends.

The hydroxy-terminated rubber (E) also contributes to a homogenization of the morphology of the composition, which similarly to the case of the non-functionalized rubber (D) positively influences the mechanical properties of the composition according to the present invention and the mechanical properties of the obtainable moldings, respectively.

Particularly suitable materials are hydroxy-terminated hydrocarbon-based rubbers with a molar mass Mw of from 500 to 60 000 g/mol, in particular from 1000 to 50 000 g/mol, preferably from 1000 to 30 000 g/mol, for example from 1000 to 15 000 g/mol, determined from GPC with light scattering in hexafluoroisopropanol (HFIP) at 40° C.

Suitable materials are hydrocarbon-based rubbers with a Tg value of from −150° C. to 25° C., determined under nitrogen as inert gas via Differential Scanning calorimetry (DSC) with a start temperature of −180° C., an end temperature of 200° C., and a heating rate of 20 [K/min].

The hydroxy-terminated rubber (E) used can comprise hydroxy-terminated rubbers such as synthetic hydroxy-terminated polyisoprene rubber, hydroxy-terminated polybutadiene rubber, hydroxy-terminated polyisobutylene-polybutene-butyl rubber, hydroxy-terminated ethylene-propylene-copolymer rubber, hydroxy-terminated ethylene-1-butene-copolymer rubbers, hydroxy-terminated ethylene-propylene-1-butene-copolymer rubbers, hydroxy-terminated ethylene-1-hexene-copolymer rubbers, hydroxy-terminated ethylene-1-octene-copolymer rubbers, hydroxy-terminated ethylene-styrene-copolymer rubbers, hydroxy-terminated ethylene-norbornene-copolymer rubbers, hydroxy-terminated propylene-1-butene-copolymer rubbers, hydroxy-terminated ethylene-1-butene-unconjugated-diene-copolymer rubbers, and mixtures thereof. Hydroxy-terminated rubbers (E) of this type can be produced as described in U.S. Pat. No. 4,448,956, p. 2, lines 5-64.

It is also possible to use hydroxy-terminated styrene rubbers, hydroxy-terminated styrene-butadiene-diblock copolymers, such as hydroxy-terminated styrene-butadiene-styrene-triblock copolymers, hydroxy-terminated styrene-isoprene-diblock copolymers, hydroxy-terminated styrene-isoprene-styrene-triblock copolymers, hydroxy-terminated hydrogenated styrene-butadiene-diblock copolymers, hydroxy-terminated hydrogenated styrene-butadiene-styrene-triblock copolymers, hydroxy-terminated hydrogenated styrene-isoprene-diblock copolymers, hydroxy-terminated styrene-isoprene-styrene-triblock copolymers, and mixtures thereof. Hydroxy-terminated rubbers (E) of this type can be produced as described in U.S. Pat. No. 4,448,956, p. 2, lines 5-64.

It is also possible to use hydroxy-terminated random styrene-butadiene copolymers, hydroxy-terminated random styrene-isoprene copolymers, hydroxy-terminated random hydrogenated styrene-butadiene copolymers, hydroxy-terminated random hydrogenated styrene-isoprene copolymers, and mixtures thereof. Hydroxy-terminated rubbers (E) of this type can be produced as described in U.S. Pat. No. 4,448,956, p. 2, lines 5-64.

Component (E) used can also comprise hydroxy-terminated polyalkyl acrylates, such as hydroxy-terminated poly(n-butyl) acrylates, and also hydroxy-terminated copolymers of n-butyl acrylate and ethylene or methyl methacrylate, and mixtures thereof.

Hydroxy-terminated rubbers (E) of this type can be produced as described in U.S. Pat. No. 4,448,956, p. 2, lines 5-64.

It is also possible to use mixtures of component (E).

The molar ratio of component (D) to component (E) is preferably from 1:10 to 10:1. In one preferred embodiment, the molar ratio of component (D) to component (E) is from 1:3 to 3:1.

One embodiment of the invention comprises a process for producing a composition comprising the following components:
(A) at least one lactam
(B) at least one catalyst
(C) an activator from the group of the isocyanates, anhydrides, acyl halides, reaction products of these with (A), and mixtures of these
(D) at least one non-functionalized styrene-butadiene block copolymer and/or one non-functionalized random styrene-butadiene copolymer
(E) at least one hydroxy-terminated polybutadiene rubber.

The composition can also comprise, alongside components (A) to (E), further additives (F). The further additives are used to adjust the properties of the polyamide that can be produced from the composition. Examples of conventional additives are dyes, mold-release agents, viscosity improvers, and flame retardants.

The composition can preferably comprise
(A) from 50 to 99.5% by weight of at least one lactam
(B) from 0.1 to 10% by weight of at least one catalyst
(C) from 0.1 to 5% by weight of an activator from the group of the isocyanates, anhydrides, acyl halides, reaction products of these with (A), and mixtures of these
(D) from 0.25 to 45% by weight of at least one non-functionalized rubber
(E) from 0.05 to 25% by weight of at least one hydroxy-terminated rubber,

where the % by weight data are based on components (A) to (E) and the total here is 100% by weight.

In another embodiment of the invention, the composition which can comprise components A) to E) and optionally F) can be heated to a temperature suitable for the polymerization of the lactam. Heating of the composition to a temperature suitable for the polymerization of the lactam generally gives a thermoset. In particular, the composition comprising components A) to E) and optionally F) can be heated to a temperature in the range from 40 to 240° C., preferably from 100 to 170° C., and a polymeric solid phase is formed here. It is also possible to heat the composition without any textile structure.

One variant of the process comprises dissolving components (A), (D), and (E) at a temperature in the range from 40 to 240° C., then adding (C), whereupon a prepolymer is formed, which subsequently is reacted with component (B) at a temperature in the range from 10 to 120° C. to obtain a solid polymeric phase.

The invention also provides processes for producing a molding comprising the following steps:
(a) producing separate mixtures
   s1) comprising at least one lactam (A), one activator (C), and one hydroxy-terminated rubber (E)
   s2) comprising at least one lactam (A) and at least one catalyst (B), and one non-functionalized rubber (D)
(b) injecting the combined mixtures s1) and s2) into a hot mold with inserted textile structure
(c) ejecting the resultant molding from the mold.

The invention also provides processes for producing a molding comprising the following steps:
(a) producing separate mixtures
   s1) comprising at least one lactam (A), one activator (C), one hydroxy-terminated rubber (E), and one non-functionalized rubber (D)
   s2) comprising at least one lactam (A) and at least one catalyst (B), and one non-functionalized rubber (D)
(b) injecting the combined mixtures s1) and s2) into a hot mold with inserted textile structure
(c) ejecting the resultant molding from the mold.

Mixing procedures can be carried out in a static or dynamic mixer.

A feature of the composition of the invention is that there is no restriction on the nature of the molds in which it can be used. In particular, the process described can make particularly effective use of molds for producing thin-walled moldings which require large melt flow path lengths.

Other additions can optionally be added during the mixing of the melts, examples being mold-release agents or viscosity improvers.

The residence time of the molding in the mold depends on the circumstances of the individual case, for example the injection temperature and the complexity of the molding. Typical residence times can be in the range of seconds to double-digit minutes. By way of example, residence times can be in the range from 30 sec to 10 min. After the residence time, the molding is ejected from the mold.

The temperature of the mold depends on the circumstances of the individual case, in particular on the components used and on the complexity of the molding. A hot mold usually means a mold with a temperature of from 90 to 250° C., in particular from 100 to 200° C.

A textile structure for the purposes of the invention is an association of fibers or of fiber bundles. It may be single- or multi-ply. It may for example be a woven, knit, braid, laid scrim or nonwoven. For the purposes of the present invention, a textile structure means wovens made of at least one ply, preferably of more than one ply, knits made of one or more plies, braids made of one or more plies, laid scrims, at least one ply, preferably a plurality of plies, made of parallel-oriented fibers, fiber bundles, yarns, threads or cordage, where the individual plies of the parallel-oriented fibers or fiber bundles of yarns, threads or cordage can be mutually nonparallel, or nonwovens. It is preferable that the textile structures take the form of wovens or of plies of parallel-oriented fibers or fiber bundles such as yarns, threads or cordage.

If in the case of laid scrims the plies of parallel-oriented fibers or fiber bundles such as yarns, threads or cordage are used in mutually nonparallel form, it is particularly preferable that the angle of rotation between the individual plies is respectively 90° (bidirectional structure). If the number of plies used is three or a multiple of three, it is also possible to arrange the angle of rotation between the individual plies to be 60°, and if the number of plies is four or a multiple of four it is also possible to arrange the angle of rotation between the individual plies to be 45°. It is moreover also possible to provide more than one ply of fibers or fiber bundles with identical orientation. It is also possible here that plies are mutually nonparallel, where the number of plies with fibers or fiber bundles of identical orientation in each of the orientations of the fibers or fiber bundles can differ, an example being four plies in one first direction and one ply in a direction where the angle of rotation between these directions is, for example, 90° (bidirectional structure with preferential direction). There is also a known quasi-isotropic structure in which the arrangement has the fibers of a second ply at an angle of rotation of 90° between these and fibers or fiber bundles of a first ply, and moreover has fibers or fiber bundles of a third ply with an angle of rotation of 45° between these and the fibers or fiber bundles of the second ply.

It is particularly preferable to use, for production of the fiber-reinforced moldings, textile structures in from 2 to 10 plies, in particular in from 2 to 6 plies.

The textile structures used preferably comprise, as fibers, fibers made of inorganic minerals, such as carbon, for example in the form of low-modulus carbon fibers or high-modulus carbon fibers, silicatic and non-silicatic glasses of a very wide variety of types, boron, silicon carbide, potassium titanate, metals, metal alloys, metal oxides, metal nitrides, metal carbides or silicates, and also organic materials, such as natural and synthetic polymers, e.g. polyacrylonitriles, polyesters, ultrahigh-draw polyolefin fibers, polyamides, polyimides, aramids, liquid-crystal polymers, polyphenylene sulfides, polyether ketones, polyether ether ketones, polyetherimides, cotton, cellulose or other natural fibers, such as flax, sisal, kenaf, hemp or abaca. Preference is given to high-melting-point materials, such as glasses, carbon, aramids, potassium titanate, liquid-crystal polymers, polyphenylene sulfides, polyether ketones, polyether ether ketones and polyetherimides, and particular preference is given to glass fibers, carbon fibers, aramid fibers, steel fibers, potassium titanate fibers, ceramic fibers, and/or other sufficiently heat-resistant polymeric fibers or filaments.

The textile structures can also, of course, be composed of fibers of different material.

The invention also provides the moldings resulting from the process described above. By virtue of the composition, a feature of said moldings is that they can easily be ejected from the mold in at least 90% of the cases at the end of the production process. Another simultaneous feature of the moldings is that the penetration energy needed to puncture the molding in accordance with the ISO6603 puncture test is from 50 to 65 J, measured on a square molding measuring 60 mm×60 mm, at a temperature of 23° C. and at 50% humidity, using a falling weight with impact velocity 4.2 m/s and mass 43 kg, where the molding was previously dried for 7 days at 80° C. in a vacuum drying oven.

### EXAMPLES

The invention is explained in more detail on the basis of the examples below, but is not restricted thereto.

Intrinsic Viscosity (IV):

The values determined provide a relative measure of the molar mass of polyimide. They were measured by producing a 0.5% solution of the polymer in 96% sulfuric acid at room temperature. To the extent that the test specimen comprised glass fibers, these were removed by filtration using a Duran (D 2) suction filter funnel prior to the viscosity measurement. The resultant solution was then charged to an Ubbelohde capillary viscometer from Schott (IIa) and temperature-controlled to 25.0° C. in a Schott transparent thermostat. The flow times for the specimen solution and for the solvent were then determined and used to calculate the IV.

Puncture Test (PT):

The penetration energy was determined by the ISO6603 puncture test and provides a measure of toughness. These measurements were made in “Fractovis” test equipment from CEAST. For these tests, prior to the measurement, square test specimens measuring 60 mm×60 mm were cut out from the moldings produced, and these were dried for 7 days at 80° C. in a vacuum drying oven. The puncture test was carried out at a temperature of 23° C. and 50% humidity. The impact velocity of the falling weight was 4.2 m/s and its mass was 43 kg. The impact energy was 380 J, and the force sensor value was 22 kN.

Hydroxy-terminated polybutadiene (PBuOH): liquid hydroxy-terminated polybutadiene with a molar mass of Mn=2800 g/mol, determined from GPC with light scattering in hexafluoroisopropanol (HFIP) at 40° C., and with a degree of polymerization of about 50. Hydroxy functionality was 2.5.

Non-functionalized polybutadiene (PBu): liquid polybutadiene with a molar mass of Mw=8000 g/mol, determined from GPC with light scattering in hexafluoroisopropanol (HFIP) at 40° C.

Styrene-butadiene copolymer: random styrene-butadiene copolymer (65% by weight of styrene, 35% by weight of butadiene with a molar mass of Mn=135 000 g/mol, determined from GPC with light scattering in hexafluoroisopropanol (HFIP) at 40° C.

Processing Methods:

1. Anionic polymerization in a calorimeter (without fibers):

All of the polymerization reactions were carried out at 140° C., with stirring, in a dry nitrogen atmosphere in a 50 ml glass calorimeter reactor which had been sealed with a grease-free Teflon stopper and provided with a temperature sensor. Table 1 lists the results. The examples below explain the detail of the experimental method.

TABLE 1

| | Comp. | Comp. | Comp. | Comp. | | | | Comp. | Comp. | Comp. |
|---|---|---|---|---|---|---|---|---|---|---|
| | Ex. | Ex. | Ex. | Ex. | | | | Ex. | Ex. | Ex. |
| Example | 1 | 2 | 3 | 4 | 1 | 2 | 3 | 5 | 6 | 7 |
| Lactam | 94 | 88 | 82 | 69 | 89 | 84 | 87 | 89 | 84 | 74 |
| (% by wt.) | | | | | | | | | | |
| PBu | — | — | — | — | 4 | 8 | 16 | 5 | 10 | 20 |
| (% by wt.) | | | | | | | | | | |
| PBu OH | — | 5 | 10 | 20 | 1 | 2 | 4 | — | — | — |
| (% by wt.) | | | | | | | | | | |
| C10 catalyst | 4 | 4 | 4 | 4 | 4 | 4 | 4 | 4 | 4 | 4 |
| (% by wt.) | | | | | | | | | | |
| C20 activator | 2 | 3 | 4 | 7 | 2 | 2 | 2 | 2 | 2 | 2 |
| (% by wt.) | | | | | | | | | | |
| Molar amount of | — | — | — | — | 0.05 | 0.1 | 0.2 | 0.063 | 0.125 | 0.25 |
| PBu (mmol) | | | | | | | | | | |
| Molar amount of | — | 0.179 | 0.357 | 0.714 | 0.036 | 0.071 | 0.143 | — | — | — |
| PBudiOH (mmol) | | | | | | | | | | |
| PBu/PBudiOH ratio | — | — | — | — | 1.39 | 1.41 | 1.40 | — | — | — |

Comparative examples 2, 3, and 4 by analogy with EP 243 177

Comparative examples 5, 6, 7 by analogy with DE 3 534 949

### Comparative Example 1

9.40 g of caprolactam and 0.200 g of Bruggolen C20 activator (80% of caprolactam-capped hexamethylene 1,6-diisocyanate in caprolactam, Brüggemann K G, Heilbronn) were dissolved at 140° C. in the reactor. 0.400 g of Brüggolen C10 catalyst (18% of sodium caprolactam in caprolactam, Brüggemann K G, Heilbronn) in the form of solid was then added at 20° C. to the molten mixture. The anionic polymerization reaction was then terminated by cooling the reactor in water (10° C.).

### Comparative Example 2

8.80 g of caprolactam and 0.500 g of hydroxy-terminated polybutadiene were dissolved at 140° C. in the reactor. 0.30 g of Brüggolen C20 activator (80% of caprolactam-capped hexamethylene 1,6-diisocyanate in caprolactam, Brüggemann K G, Heilbronn) was then added in the form of solid at RT to the molten mixture. The mixture was stirred at 140° C. for 15 min, and during this process the prepolymer formed in-situ. Without isolation of said prepolymer, 0.40 g of Brüggolen C10 catalyst (18% of sodium caprolactam in caprolactam, Brüggemann K G, Heilbronn) was then added in the form of solid at RT to the molten mixture. The anionic polymerization reaction was then terminated by cooling the reactor in water (10° C.).

### Comparative Example 3

Example 2 was repeated, except that 1000 g of hydroxy-terminated polybutadiene and 0.40 g of Brüggolen C20 activator were used.

### Comparative example 4

Example 2 was repeated, except that 2000 g of hydroxy-terminated polybutadiene and 0.70 g of Brüggolen C20 activator were used.

### Inventive Example 1

8.90 g of caprolactam, 0.400 g of non-functionalized polybutadiene and 0.10 g of hydroxy-terminated polybutadiene were dissolved at 140° C. in the reactor. 0.20 g of Brüggolen C20 activator (80% of caprolactam-capped hexamethylene 1,6-diisocyanate in caprolactam, Brüggemann K G, Heilbronn) was then added in the form of solid at 20° C. to the molten mixture. The mixture was stirred at 140° C. for 30 min, and during this process the prepolymer formed in-situ. Without isolation of said prepolymer, 0.40 g of Brüggolen C10 catalyst (18% of sodium caprolactam in caprolactam, Brüggemann K G, Heilbronn) was then added in the form of solid at 20° C. to the molten mixture. The anionic polymerization reaction was then terminated by cooling the reactor in water (10° C.).

### Inventive Example 2

Inventive example 1 was repeated, except that 0.80 g of non-functionalized polybutadiene and 0.20 g of hydroxy-terminated polybutadiene were used.

### Inventive Example 3

Inventive example 1 was repeated, except that 1.60 g of non-functionalized polybutadiene and 0.40 g of OH-terminated polybutadiene were used.

### Comparative Example 5

8.90 g of caprolactam and 0.50 g of non-functionalized polybutadiene were dissolved at 140° C. in the reactor. 0.20 g of Brüggolen C20 activator (80% of caprolactam-capped hexamethylene 1,6-diisocyanate in caprolactam, Brüggemann K G, Heilbronn) was then added in the form of solid at RT to the molten mixture. The mixture was stirred at 140° C. for 15 min. 0.40 g of Brüggolen 010 catalyst (18% of sodium caprolactam in caprolactam, Brüggemann K G, Heilbronn) was then added in the form of solid at 20° C. to the molten mixture. The anionic polymerization reaction was then terminated by cooling the reactor in water (10° C.).

### Comparative Example 6

Comparative example 5 was repeated, except that 1.00 g of non-functionalized polybutadiene was used.

### Comparative Example 7

Comparative example 5 was repeated, except that 2.00 g of non-functionalized polybutadiene was used.

2. Production of Moldings:

The moldings were produced in the RIM process in a heatable mold carrier. For this process, the various components were mixed in a casting machine from Tartler, Michelstadt. The casting system was composed of three containers, each with a volume of 20 liters, each equipped with a pump with a conveying rate of from 40-400 ccm/min. In accordance with RIM technology, the various components were mixed in a ratio of 1:1 in a dynamic mixer (mixing temperature: 122° C.) at 6000 rpm. The mixture was introduced into a closed mold which had been heated to 155° C. and filled with 8 plies of fibers (FK801 size, glass-filament woven: weight per unit area 280.0 g/m²±5%, determined in accordance with DIN EN 12127, warp yarn EC9-68×3 t0, weft yarn EC9-204, 7.0 ends/cm±5%, 6.5 picks/cm±5% determined in accordance with DIN EN 1049, moisture content smaller than 0.1%±1%, determined in accordance with DIN EN 3616, thickness (guideline value dry), 0.35 mm±5%, determined in accordance with DIN ISO 4603/E). The dimensions of this mold were 340×340×4 mm and its volume was 360 cm³. After 10 min of reaction in the mold, the finished molding was removed. Table 2 lists the results. The examples below explain the detail of the experimental method.

TABLE 2

| | Comp. | Comp. | Comp. | | | | | Comp. | Comp. |
|---|---|---|---|---|---|---|---|---|---|
| | Ex. | Ex. | Ex. | | | | | Ex. | Ex. |
| Example | 8 | 9 | 10 | 4 | 5 | 6 | 7 | 11 | 12 |
| Lactam | 94 | 88 | 82 | 89 | 84 | 87 | 84 | 89 | 84 |
| (% by wt.) | | | | | | | | | |
| Styrene-butadiene | — | — | — | — | — | — | 8 | — | — |
| copolymer | | | | | | | | | |
| LBR-307 PBu | — | — | — | 4 | 8 | 16 | — | 5 | 10 |
| (% by wt.) | | | | | | | | | |
| Poly BD R-45 | — | 5 | 10 | 1 | 2 | 4 | 2 | — | — |
| HTLO PBudiOH | | | | | | | | | |
| (% by wt.) | | | | | | | | | |
| C10 catalyst | 4 | 4 | 4 | 4 | 4 | 4 | 4 | 4 | 4 |
| (% by wt.) | | | | | | | | | |
| C20 activator | 2 | 3 | 4 | 2 | 2 | 2 | 2 | 2 | 2 |
| (% by wt.) | | | | | | | | | |
| Molar amount of | — | — | — | 0.05 | 0.1 | 0.2 | — | 0.063 | 0.125 |
| PBu (mmol) | | | | | | | | | |
| Molar amount of | — | 0.179 | 0.357 | 0.036 | 0.071 | 0.143 | — | — | — |
| PBudiOH (mmol) | | | | | | | | | |
| PBu/PBudiOH | — | — | — | 1.39 | 1.41 | 1.40 | — | — | — |
| ratio | | | | | | | | | |
| PT (J) | 37 | 35 | 39 | 53 | 53 | 55 | 57 | 45 | 49 |
| IV (g/ml) * | 507 | 359 | 266 | 439 | 479 | 417 | 440 | 486 | 447 |

* The IV is measured on the molding, i.e. small pieces are cut out from the molding and then subjected to the IV analysis. The glass fiber is separated off prior to the measurement (for method, see above)

Comparative examples 9, 10 by analogy with EP 243 177

Comparative examples 11, 12 by analogy with DE 3 534 949

### Comparative Example 8

### Production of a Molding

Composition of A Container:
4% by weight of Brüggolen C10
47% by weight of caprolactam

Composition of B Container:
2% by weight of Brüggolen C20
47% by weight of caprolactam
0.2% by weight of calcium stearate

The Brüggolen C20 activator (80% of caprolactam-capped hexamethylene 1,6-diisocyanate in caprolactam, Brüggemann K G, Heilbronn) and the Brüggolen C10 activator (18% of sodium caprolactam in caprolactam, Brüggemann K G, Heilbronn) were added in the form of solids to the fresh caprolactam melts at 112° C. in the containers A and B, with stirring and under N₂. 0.2% of calcium stearate was also added as internal mold-release agent to the B container. The two mixtures were then injected in a ratio of 1:1 into the closed mold which had been heated to 155° C. and filled with 8 plies of fibers (FK801 size, glass-filament woven: weight per unit area 280.0 g/m²±5%, determined in accordance with DIN EN 12127, warp yarn EC9-68×3 t0, weft yarn EC9-204, 7.0 ends/cm±5%, 6.5 picks/cm±5%, determined in accordance with DIN EN 1049, moisture content smaller than 0.1%±1%, determined in accordance with DIN EN 3616, thickness (guideline value dry), 0.35 mm±5%, determined in accordance with DIN ISO 4603/E). After 10 min at 155° C. in the mold, the finished molding was removed without demolding problems. In 999 of 1000 experiments, the molding could be released without difficulty from the mold. A molding with smooth surface and without discoloration was obtained. The intrinsic viscosity was 507.

### Comparative Example 9

### Production of Molding with 5% of PBudiOH

Composition of A Container:
4% by weight of Brüggolen C10
44% by weight of caprolactam

Composition of B Container:
3% by weight of Brüggolen C20
5% by weight OH-terminated polybutadiene
44% by weight of caprolactam
0.2% by weight of calcium stearate

The Brüggolen C20 activator (80% of caprolactam-capped hexamethylene 1,6-diisocyanate in caprolactam, Brüggemann K G, Heilbronn) and the Brüggolen C10 activator (18% of sodium caprolactam in caprolactam, Brüggemann K G, Heilbronn) were added in the form of solids to the fresh caprolactam melts at 112° C. in the containers A and B, with stirring and under N₂. 0.2% of calcium stearate was also added as internal mold-release agent to the B container. The OH-terminated polybutadiene was then added to the container B and dissolved within 15 min. The two mixtures were then injected in a ratio of 1:1 into the closed mold which had been heated to 155° C. and filled with 8 plies of fibers (FK801 size, glass-filament woven: weight per unit area 280.0 g/m²±5%, determined in accordance with DIN EN 12127, warp yarn EC9-68×3 t0, weft yarn EC9-204, 7.0 ends/cm±5%, 6.5 picks/cm±5%, determined in accordance with DIN EN 1049, moisture content smaller than 0.1%±1%, determined in accordance with DIN EN 3616, thickness (guideline value dry), 0.35 mm±5%, determined in accordance with DIN ISO 4603/E). After 10 min at 155° C. in the mold, the finished molding was removed without demolding problems (at concentrations of 10% of OH-terminated polybutadiene, demolding is possible without difficulty in the case of 9 of 100 parts). A molding with smooth surface was obtained. The intrinsic viscosity was 359.

### Comparative Example 10

### Production of a Polyamide Molding with 10% of OH-Terminated Polybutadiene

Comparative example 1 was repeated, except that 10% of OH-terminated polybutadiene was used. A molding with smooth surface was obtained (at concentrations of 10% of OH-terminated polybutadiene, demolding is possible without difficulty in the case of 9 of 100 parts). The IV was 266.

### Inventive Example 4

### Production of a Molding with 4% PBu and 1% of PBudiOH

Composition of A Container:
4% by weight of Brüggolen C10
2% by weight of non-functionalized polybutadiene
44.5% by weight of caprolactam

Composition of B Container:
2% by weight of Brüggolen C20
2% by weight of non-functionalized polybutadiene
1% by weight of OH-terminated polybutadiene
44.5% by weight of caprolactam
0.2% by weight of calcium stearate

The Brüggolen C20 activator (80% of caprolactam-capped hexamethylene 1,6-diisocyanate in caprolactam, Brüggemann K G, Heilbronn) was introduced into container B. The Brüggolen C10 activator (18% of sodium caprolactam in caprolactam, Brüggemann K G, Heilbronn) was introduced into container A. A caprolactam melt was added at 112° C. under N₂ to both containers A and B. 0.2% of calcium stearate was moreover added as internal mold-release agent to the B container. The hydroxy-terminated rubber was then added to container A and the non-functionalized rubber was then added to container B and these were dissolved within 15 min. The two mixtures in a ratio of 1:1 were then injected in a ratio of 1:1 into the closed mold which had been heated to 155° C. and filled with 8 plies of fibers (FK801 size, glass-filament woven: weight per unit area 280.0 g/m²±5%, determined in accordance with DIN EN 12127, warp yarn EC9-68×3 t0, weft yarn EC9-204, 7.0 ends/cm±5%, 6.5 picks/cm±5%, determined in accordance with DIN EN 1049, moisture content smaller than 0.1%±1%, determined in accordance with DIN EN 3616, thickness (guideline value dry), 0.35 mm±5%, determined in accordance with DIN ISO 4603/E). After 10 min at 155° C. in the mold, the finished molding was removed without demolding problems. A molding with smooth surface and without discoloration was obtained. When 4% by weight of non-functionalized polybutadiene is used, it is not possible to release 9 out of 10 parts from a mold without difficulty. The IV was 439.

### Inventive Example 5

### Production of a Molding with 8% of Non-Functionalized Polybutadiene and 2% of OH-Terminated Polybutadiene

Inventive example 4 was repeated, except that 8% of non-functionalized polybutadiene and 2% of OH-terminated polybutadiene were used. A molding with smooth surface and without discoloration was obtained. When 8% of non-functionalized polybutadiene is used it is no longer possible to release 9 out of 10 parts from a mold without difficulty. The IV was 479.

### Inventive Example 6

### Production of a Molding with 16% of Non-Functionalized Polybutadiene and 4% of OH-Terminated Polybutadiene

Inventive example 4 was repeated, except that 16% of non-functionalized polybutadiene and 4% of hydroxy-terminated polybutadiene were used. A molding with smooth surface and without discoloration was obtained. The IV was 417.

When 16% of non-functionalized polybutadiene was used, it was no longer possible to release 99 out of 100 parts from a mold without difficulty.

### Comparative 11

### Production of a Molding with 5% of Non-Functionalized Polybutadiene

Composition of A Container:
4% by weight of Brüggolen C10
2.5% by weight of non-functionalized polybutadiene
44.5% by weight of caprolactam

Composition of B Container:
2% by weight of Brüggolen C20
2.5% by weight of non-functionalized polybutadiene
44.5% by weight of caprolactam
0.2% by weight of calcium stearate

The Brüggolen C20 activator (80% of caprolactam-capped hexamethylene 1,6-diisocyanate in caprolactam, Brüggemann K G, Heilbronn) was added to a container B. The Brüggolen C10 catalyst (18% of sodium caprolactam in caprolactam, Brüggemann K G, Heilbronn) was added to a container A. A caprolactam melt was added at 112° C. with stirring and under N₂ to both containers. 0.2% of calcium stearate was moreover added as internal mold-release agent to the B container. Non-functionalized polybutadiene was then added to containers A and B and dissolved within 15 min. The two mixtures were then injected in a ratio of 1:1 into the closed mold which had been heated to 155° C. and filled with 8 plies of fibers (FK801 size, glass-filament woven: weight per unit area 280.0 g/m²±5%, determined in accordance with DIN EN 12127, warp yarn EC9-68×3 t0, weft yarn EC9-204, 7.0 ends/cm±5%, 6.5 picks/cm±5%, determined in accordance with DIN EN 1049, moisture content smaller than 0.1%±1%, determined in accordance with DIN EN 3616, thickness (guideline value dry), 0.35 mm±5%, determined in accordance with DIN ISO 4603/E). After 10 min at 155° C. in the mold, the finished molding was removed from the mold with difficulty. A molding with partially tacky surface was obtained. The IV was 486.

### Comparative Example 12

### Production of a Molding with 10% of Non-Functionalized Polybutadiene

The comparative example was repeated, except that 10% of non-functionalized polybutadiene was used. The molding exhibited severe adhesion in the mold and was very difficult to demold. The surface was rough and very tacky. The IV was 447.

### Example 7

### Production of a Molding with 8% by Weight of a Random Styrene-Butadiene Copolymer and 2% by Weight of Hydroxy-Terminated Polybutadiene

Composition of A Container:
4% by weight of Brüggolen C10
4% by weight of random styrene-butadiene copolymer
42% by weight of caprolactam

Composition of B Container:
2% by weight of Brüggolen C20
4% by weight of random styrene-butadiene copolymer
2% by weight of hydroxy-terminated polybutadiene
42% by weight of caprolactam
0.2% by weight of calcium stearate

The Brüggolen C20 activator (80% of caprolactam-capped hexamethylene 1,6-diisocyanate in caprolactam, Brüggemann K G, Heilbronn) and the Brüggolen 010 catalyst (18% of sodium caprolactam in caprolactam, Brüggemann K G, Heilbronn) were added in the form of solids to the fresh caprolactam melts at 112° C. in containers A and B, with stirring and under N₂. 0.2% of calcium stearate was added as internal mold-release agent to the B container. The rubber additives were then added to containers A and B and dissolved within 15 min. The two mixtures were then injected in a ratio of 1:1 into the closed mold which had been heated to 155° C. and filled with 8 plies of fibers (FK801 size, glass-filament woven: weight per unit area 280.0 g/m²±5%, determined in accordance with DIN EN 12127, warp yarn EC9-68'3 t0, weft yarn EC9-204, 7.0 ends/cm±5%, 6.5 picks/cm±5%, determined in accordance with DIN EN 1049, moisture content smaller than 0.1%±1%, determined in accordance with DIN EN 3616, thickness (guideline value dry), 0.35 mm±5%, determined in accordance with DIN ISO 4603/E). After 10 min at 155° C. in the mold, the finished molding was removed from the mold without any demolding problems. The IV was 440.

1-15. (canceled)

16. A composition comprising:
(A) at least one lactam
(B) at least one catalyst
(C) an activator selected from the group consisting of of isocyanates, anhydrides, acyl halides, reaction products of these with (A), and mixtures of these
(D) at least one non-functionalized rubber, which comprises no functional groups having heteroatoms
(E) at least one hydroxy-terminated rubber.

17. The composition according to claim 16 comprising
(A) from 50 to 99.5% by weight of at least one lactam
(B) from 0.1 to 10% by weight of at least one catalyst
(C) from 0.1 to 5% by weight of an activator selected from the group consisting of isocyanates, anhydrides, acyl halides, reaction products of these with (A), and mixtures of these
(D) from 0.25 to 45% by weight of at least one non-functionalized rubber, which comprises no functional groups having heteroatoms
(E) from 0.05 to 25% by weight of at least one hydroxy-terminated rubber, where the % by weight data are based on components (A) to (E) and the total here is 100% by weight.

18. The composition according to claim 16, where the weight-average molar mass of the non-functionalized rubber (D) is from 500 to 300 000 g/mol, determined from GPC with light scattering in hexafluoroisopropanol (HFIP) at 40° C.

19. The composition according to claim 16, where the Tg value of the non-functionalized rubber (D) is from −150° C. to 25° C., determined under nitrogen as inert gas by Differential Scanning calorimetry (DSC) with a start temperature of −180° C., an end temperature of 200° C., and a heating rate of 20 [K/min].

20. The composition according to claim 16, where the weight-average molar mass determined by means of light scattering for the hydroxy-terminated rubber (E) is from 500 to 60 000 g/mol.

21. The composition according to claim 16, wherein component (D) comprises at least one non-functionalized styrene-butadiene block copolymer and/or one non-functionalized random styrene-butadiene copolymer at least one hydroxy-terminated polybutadiene rubber.

22. The composition according to claim 16, wherein component
(D) comprises at least one non-functionalized styrene-butadiene block copolymer and/or one non-functionalized random styrene-butadiene copolymer and component
(E) comprises at least one hydroxy-terminated rubber.

23. The composition according to claim 16, where the molar ratio of component (D) to component (E) is from 1:10 to 10:1.

24. A process which comprises exposing the composition according to claim 16 to a temperature in the range from 40 to 240° C. to obtain a solid polymeric phase.

25. A process which comprises dissolving in the composition according to claim 16 components (A), (D) and (E) at a temperature in the range from 40 to 240° C., then adding (C), whereupon a prepolymer is formed, which subsequently is reacted with component (B) at a temperature in the range from 10 to 120° C. to obtain a solid polymeric phase.

26. A process for producing a molding comprising
(a) producing separate mixtures
s1) comprising at least one lactam (A), one activator (C), and one hydroxy-terminated rubber (E)
s2) comprising at least one lactam (A) and at least one catalyst (B), and one non-functionalized rubber (D), which comprises no functional groups having heteroatoms
(b) injecting the combined mixtures s1) and s2) into a hot mold with inserted textile structure
(c) ejecting the resultant molding from the mold.

27. A process for producing a molding comprising
(a) producing separate mixtures
s1) comprising at least one lactam (A), one activator (C), one hydroxy-terminated rubber (E), and one non-functionalized rubber (D)
s2) comprising at least one lactam (A) and at least one catalyst (B), and one non-functionalized rubber (D), which comprises no functional groups having heteroatoms
(b) injecting the combined mixtures s1) and s2) into a hot mold with inserted textile structure
(c) ejecting the resultant molding from the mold.

28. A process according to claim 26, where the textile structures are wovens, knits, laid scrims, or nonwovens made of glass fibers, of carbon fibers, and/or of aramid fibers.

29. A molding obtainable according to claim 26.

30. A molding according to claim 29, where the penetration energy needed to puncture the molding in accordance with the ISO6603 puncture test is from 50 to 65 J, measured on a square molding measuring 60 mm×60 mm, at a temperature of 23° C. and at 50% humidity, using a falling weight with impact velocity 4.2 m/s and mass 43 kg.

31. A process according to claim 27, where the textile structures are wovens, knits, laid scrims, or nonwovens made of glass fibers, of carbon fibers, and/or of aramid fibers.
